(19) United States
(12) Patent Application Publication
(10) Pub. No.: US 2009/0304886 A1
(43) Pub. Date: Dec. 10, 2009

(54) Coffee bean roasting apparatus and method of roasting coffee beans

(76) Inventor: David Greenfield, San Francisco, CA (US)

Correspondence Address: David Greenfield, 2129 Harrison St., San Francisco, CA, 94110, US

(21) Appl. No.: 12/157,119

(22) Filed: Jun. 9, 2008

(51) Int. Cl. A23F 5/04; A23N 12/08

(52) U.S. Cl. 426/467; 99/474; 34/362; 34/493

(57) ABSTRACT

A coffee bean roasting apparatus for commercial application, which provides uniform roasting of coffee beans under conditions of accurate control of product properties and without risk of damaging of the beans. This is achieved by roasting the beans in a fluidized bed of hot air directed to the beans contained in a cylindrical roasting chamber through a plurality of nozzles located in the roast chamber plenum and oriented in a tangential direction to imaginary concentric circles inside the contours of the tapered distribution plate that separates the roast chamber from the roast chamber plenum and supports the aforementioned nozzles. A predetermined pressure of hot-air blower and tangential direction of the nozzles provide movement of the entire mass of fluidized coffee beans during roasting in a circular direction as a unity substantially without relative movement of the beans with respect to each other and with excellent and uniform heat-transfer conditions between the beans.

### FIELD OF THE INVENTION

The present invention relates to food industry, and more specifically, to an apparatus and method for roasting coffee beans. More specifically, the invention relates to an apparatus and method for roasting green coffee beans in a fluidized bed of a hot air. The apparatus of the invention is a commercial coffee roaster that may find use in food shops, coffee shops, cafes, restaurants, small coffee productions, and other facilities.

### BACKGROUND OF THE INVENTION

In a majority of cases most coffee is sold preroasted and preground. However, when the coffee beans are ground or preroasted, they begin losing their flavor as soon after it is roasted. Ground coffee loses a significant amount of flavor within hours of being ground while roast coffee stored as whole beans will maintain its flavor reasonably well for approximately one week if sealed in an air tight container to minimize oxidation of the oils. On the other hand, green coffee may be kept with little effect on its potential flavor content.

For developing the flavor and aroma desired by consumers, the green coffee beans are roasted. The roasting process is very complicated as it is accompanied by complex, thermally-induced chemical reactions which convert more than 1000 elements of flavor of the green coffee beans to collectively produce the desirable flavor, color, and aroma which are inherent in roasted coffee.

Coffee roasting requires careful control of various factors such as temperature, time of exposure to specific temperatures, conditions of transfer of heat to the beans, contact conditions between the beans, relative positions of the beams with respect to each other during roasting, etc. Because the coffee roasting business is competitive, economic factors such as capital costs, energy costs and coffee loss during the process are of great significance.

Heretofore, a vast number of methods and apparatus for roasting coffee have been proposed. One standard roasting technique in the prior art comprises tumbling the coffee beans in a heated drum. While the hardware for the process is relatively simple, control is difficult, and it is very easy to scorch, and ruin the beans. Furthermore, smoke and oils generated in the process remain in contact with the beans and can confer a disagreeable taste. As a consequence, the industry is turning to the use of fluidized bed roasters. In systems of this type, the coffee beans are at least partially levitated by a stream of heated air, and the degree of roasting is controlled by controlling the temperature of the air and the duration of the heating cycle.

Given below is a review of some known commercial coffee beam roasters operating on the fluidized-bed principle to which the present invention pertains.

U.S. Pat. No. 3,964,175 issued to Sivetz in 1976 discloses a coffee roaster in which the roasting process is stopped when the beans reach a preselected temperature. The temperature of the roasting beans is measured by a thermocouple probe inserted into the roasting chamber at a location in which the probe contacts fluidized beans and heated air. A drawback to this approach is that coffee beans generally undergo significant changes in doneness (e.g. from light tan to dark brown) with relatively small changes in temperature. The accuracy of measurements for small temperature changes in coffee beans decreases with volume and weight of the sample size. Thus, the temperature measurement may not accurately reflect the doneness of the beans.

U.S. Pat. No. 4,394,623 issued in 1995 to R. Sewell discloses a self controlled, fluidized bed coffee roaster which provides a stream of heated air to a bed of coffee beans, monitors the temperature of the air that has passed through the bean, and, when the air temperatures reaches a predetermined set point, a controller, terminates the heating, deactivates the heater and injects water into the air stream at a point upstream of the beans to cool the system and quench the roasting process.

Many shortcomings of the prior coffee roasting systems utilizing a fluidized bed created by a flared chamber have been eliminated by the use of a rotating fluidized bed as described in U.S. Pat. No. 4,494,314 for “Coffee Roaster” issued to Harold Gell on Jan. 22, 1985. With the advent of rotating fluidized bed applications to coffee roaster technology, the problems involving the actual roasting technique have been solved. Since then the structure of the fluidized-bed roasters was improved as described in many patents published in the following years.

This finding was protected by U.S. Pat. No. 4,501,761 issued in 1985 to J. Mahlmann, et al. The patent discloses a coffee roasting method permitting control of final product properties. Gases, usually air and combustion gases, are heated to a temperature selected from the range between 200 and 240° C. A bed of coffee beans is suspended in a bubbling bed by the heated gas and maintained that way for about 2 minutes to about 10 minutes. The roasted coffee beans are subsequently discharged from the bubbling bed and cooled. The density of the roasted coffee beans is determined by the specific roasting conditions selected.

U.S. Pat. No. 5,292,005 issued in 1994 to J. Wireman, et al. discloses a bean-roasting apparatus using a controlled spinning bed or fluid bed roaster in combination with a cyclone separator for removing chaff from the heating medium. The cyclone separator is disposed above and in coaxial and abutting relationship with the roaster. The separator has a generally cylindrical shape with a plate having a plurality of louvers in the base thereof. The louvers impart rotational movement as the heating medium passes therethrough so that the chaff can be removed therefrom. In a preferred embodiment of the invention, a second centrifugal separator which is relatively small with respect to the first separator is disposed adjacent the first separator for making a final separation and returning the heated medium to the roaster.

For example, U.S. Pat. No. 5,359,788 issued in 1994 to H. Gell, Jr. discloses a coffee roaster which roasts coffee beans in an oven chamber employing both radiant and convection heating techniques while the beans are continually intermixed in a fluidized bed rotating in the horizontal plane. Roaster control means are provided to terminate the roasting process as well as quenching the beans in the oven chamber while maintaining the beans in a fluidized bed to avoid scorching or further roasting by the residual heat of the coffee bean mass. The oven chamber includes an upper transparent section through which the roasting charge of beans may be viewed and thereby allow manual control of the process in response to visual observation.

U.S. Pat. No. 5,609,097 issued in 1997 to B. Newnan discloses a coffee bean roaster provided with a cylindrically shaped transparent viewing tower in which coffee beans are roasted by an upwardly directed hot gaseous stream while being fluidized into a visually pleasing ascending central and descending outside columns during the roasting cycle. A two way valve located at the bottom of the tower permits the gaseous stream to enter the tower when the valve is in a first position and the roasted beans to be diverted to a cooling chamber when the valve is in a second position.

U.S. Pat. No. 6,260,479 issued in 2001 to J. Friedrich, et al. discloses a method and apparatus for roasting coffee with control of the roasting fluidized bed of coffee. It is governed by determining when the pyrolysis of the roasted batch is at its peak. The roasting is then stopped after a predetermined period of time. The following of the commencement of pyrolysis accurately and uniformly determines the starting period for the timing of the stoppage of the process to obtain uniform roasting result. Air circulation control conduit is provided with a vent port for gases and an inlet port for fresh air, the two ports can be simultaneously opened or closed while the control conduit is simultaneously closed or opened, respectively.

Also known in the art are a process and apparatus for treating particulate material in a stream of fluid described in EP1652576 published in 2006 (inventor: C. Dodson). The stream of fluid is directed into a toroidal zone to create a toroidal bed of the material. Particulates in the bed move in a generally helical fashion within the bed and can be entered and removed in a variety of ways depending upon the requirements of the process. The toroidal bed has a generally triangular cross-section with the radial width of the bed being in the range of about 2 to 20 percent of the outer diameter of the zone. The depth of the bed at the outer extremity of the bed is in the range of about 2 to 5 percent of the zone outer diameter, and the depth at the inner extremity is less than 1 percent of the outer diameter. The “Torbed” system proposed by this invention utilizes an inverted cone in the center of the roast chamber to redirect beans back into the fluidized bed to address the inability to provide complete control of the bed of beans during fluidization. Furthermore, the inlet ports are formed by radial slits and the distances between the slits narrow in the radial inward direction. This creates difference in supply of fluid to beans located closer to the inverted cone and to beans located closer to the periphery, and thus results in a non-uniform treatment.

The list of fluidized-bed coffee roasting apparatuses and methods is not limited by the above examples, but a common drawback of all the existing apparatuses and methods relating to fluidized-bed roasting is that some of them either do not provide complete fluidization of the treated beans and movement thereof as a unity of discrete solids which do not have movement relative to each other and do not provide uniform heating of the bean mass needed for uniform pyrolysis, while other apparatuses and methods cause uncontrolled circulation of the beans in a vertical direction with resulting tumbling and thermal inconsistencies thereof because of inadequate mutual contact.

### OBJECTS AND SUMMARY OF THE INVENTION

It is an object of the present invention to provide an apparatus and method for fluidized-bed coffee bean roasting that ensures complete fluidization of the treated beans, movement of the beans as a unity of discrete solids which do not have movement relative to each other, stable roasting temperature, uniform heating of the bean mass needed for uniform pyrolysis, and controlled circulation of the beans in horizontal planes under conditions of real fluidization at which the beans circulate as laminated flows with efficient and uniform transfer of heat between the layers.

The coffee bean roasting apparatus of the invention consists of a hollow rectangular base frame that supports on its top side main functional units and devices and retains all the drives and control devices inside the base frame.

The main functional units and devices are comprised of a cylindrical roast chamber made from a transparent heat-resistant material such as a borosilicate glass which is supported on the base-frame top by a pair of stands, and a chaff-separation cyclone separator which communicates with the cylindrical roast chamber for suction of the chaff under the effect of a pressure drop created by the cyclone separator. The lower end of the cyclone separator forms a chaff collection cup with a pull-down grip for unloading the collected chaff.

Located in the lower part of the cylindrical roast chamber is the roast chamber plenum which is separated from the main upper part of the roast chamber by a dispersion plate which has a shape tapered radially outward from the center of the plate. The dispersion plate is made, e.g., from stainless steel, and has a plurality of openings which in fact constitute outlets of short inclined tubes or nozzles that protrude into the roast chamber plenum. The taper angle of the dispersion plate may vary in the range, e.g., of 10° to 20°, and the angle of inclination of the nozzles may vary, e.g., in the range of 15° to 80°. In fact, each nozzle is a short cylindrical tube with beveled end faces on both sides of the tube.

Installed in the center of the roast chamber plenum is a discharge tube for unloading the roasted coffee beans from the cylindrical roast chamber when the roasting operation is completed. The portion of the discharge tube which is located inside the roast chamber plenum has a vertical orientation and its upper end terminates in the form of an inlet opening in the center of the tapered dispersion plate, while the part of the discharge tube that extends from the bottom of the roast chamber plenum is bent in the lateral direction and is used as an unloading spout for unloading the ready product to a receiving container. For this purpose, the outlet opening of the unloading spout is located on a certain height above the base frame in order to provide enough room for placing the receiving container.

The upper end of the discharge tube serves as a seat for a plate-like valve head that closes the inlet of the discharge tube during the roasting operation and which is raised above the dispersion plate high enough for unobstructed unloading of the roasted coffee beans from the cylindrical roast chamber to the receiving container through the discharge tube when the roasting operation is over.

The plate-like valve head is moved in the vertical direction for opening or closing the inlet opening of the discharge tube by a thin valve stem which is vertically arranged in the center of the discharge tube and is driven by a linear actuator located inside the base frame. The diameter of the discharge tube is large enough for unobstructed passage of the roasted beans.

The interior of the roast chamber plenum communicates with an inlet air duct which is connected to a pressure blower through a heater intended for heating the pressurized air stream that enters the roast chamber plenum and then is jetted through the aforementioned nozzles into the cylindrical roast chamber in the tangential direction to the mass of the coffee beans which at the stage of operation should fill a certain volume in the lower part of the roast chamber with the unloading opening being closed by the valve.

The drive, control mechanisms and devices of the coffee roasting apparatus of the invention are kept inside the base frame while the control panel of the apparatus with various control buttons, switches, indicators, and displays (or LCD operator interface) is located on the front side of the base frame. Important components of the control system are two thermocouples, i.e., an input airflow thermocouple installed in the inlet air duct for measuring temperature of the inlet airflow and a roast chamber thermocouple for measuring the temperature of beans in the cylindrical roast chamber. Pressurized flow of air is created by an air blower that is driven by an electric motor controlled by a variable frequency drive. On its way to the roast chamber plenum through the inlet air duct, the air flow passes through a heater which may be an electric or gaseous air heater. The latter is connected to a programmable logic controller (hereinafter referred as PLC), which is connected to the aforementioned input airflow thermocouple and the roast chamber plenum thermocouple. The function of the PLC is to maintain a predetermined temperature differential between the temperature of the inlet air flow and the temperature of the beans in the roast chamber. The programmable controller, in turn, is connected through a three-phase triac controller to the aforementioned heater for adjusting heating temperature in response to the output data of the aforementioned thermocouples.

The control buttons, switches, displays, and indicators on the control panel include the following: a key switch that, when switched, activates the PLC; a bean-size selector switch which is needed since the size, grade, and other conditions of the coffee beans affect the roasting regime; temperature indicator and setpoint controller; profile selector switch; emergency heat-off switch; a start switch activation of which automatically energizes the blower and the heater; the bean unload switch that energizes the valve-lift actuator; and a stop switch. (The abovementioned controls can be consolidated in an LCD operator interface as well).

The apparatus operates as follows.

A measured amount of beans is introduced into the borosilicate cylinder roast chamber. The system is energized with the key switch, which enables the PLC controller. Pushing the start switch simultaneously activates the pressure blower and the process heat source, which may be a gas heater or an electric heater.

The resultant heated airstreams passes in the form of multiple tangential jets through the numerous tangential nozzles of the dispersion plate. Such jets create a floating bed for the beans which keep the beans in a rotating and floating state in the form of laminated layers of discrete bodies of the beans, wherein the beans of each layer essentially do not collide with the beans of the neighboring layers but rather rotate under the effect of the tangential jets as a unity and without relative movements with respect to each other. Such a condition protects the beans from deterioration that normally occurs when the beans collide with each other. At the same time, the individual beans are located in close heat-transfer proximity to each other so that the entire bean load moves as a homogenous virtual solid mass having a uniform temperature through all the layers. Under such conditions the temperature of the beans determined by the roast chamber thermocouple in the bean mass will be substantially the same as in the layers close to the dispersion plate.

The PLC monitors and controls the bean load in the roast chamber with resolution of 0.01 seconds. With the roast chamber thermocouple sampling the temperature of the beans and the inlet air thermocouple sampling the inlet air temperature, the PLC continuously changes temperature of the inlet air with 1° C. of increase of the bean load temperature (or decrease) maintaining the predetermined temperature differential, e.g., 30° C. differential, between the two points of measurement. When the temperature reaches the predetermined setpoint, the heating unit is turned off and the cooling process begins.

The PLC determines how to maintain the proper temperature of the heated airstreams and regulates it utilizing a three-phase proportional triac controller, which, in turn, controls the heater (which in this case is an electric heater).

The PLC also determines how to maintain the proper airstreams pressure and volume and regulates the pressure blower utilizing a variable frequency drive determined by existing measured temperatures.

As the coffee beans cook, the resultant effluent flow is directed through the cyclone separator, which through its cyclonic action and predetermined pressure drop collects any solids (e.g., chaff), to be removed after the end of the roast cycle.

A temperature controller displays the process temperature and allows the user to select the temperature setpoint at which he/she wants the roast process to end.

Depending on which profile and what setpoint temperature is selected, the roasting process takes between 4 and 13 minutes. These profiles are switch-selectable on the front panel.

Normally the bean cooking temperature will be determined by the preset temperature differential and should not exceed 240° C. If the temperature exceeds the recommended upper limit, the PLC will automatically adjust said temperature to remain at or below the upper limit.

Once setpoint has been achieved, the heating unit is turned off and the cooling cycle begins.

The PLC determines how to maintain the proper airstreams pressure and volume based on the temperature of the bean load and directs the variable frequency drive to alter the speed of the pressure blower. Cooling takes approximately 2 minutes.

When the cooked beans have cooled to 82° C., the PLC allows the operator to select the unload switch enabling the linear actuator to raise the outlet valve and beans are displaced into the receiving container bin. Two additional pulses of air make sure no beans remain in the roast chamber.

Closing the outlet valve completes the process and resets the PLC data registers to allow for the next roast process.

### BRIEF DESCRIPTION OF THE DRAWINGS

FIG. 1 is a general three-dimensional view of a coffee bean roasting apparatus of the invention.

FIG. 2 is a sectional view through the roast chamber plenum shown on a larger scale than FIG. 1.

FIG. 3 is a control block diagram of the coffee roasting apparatus of the invention.

FIG. 4 is a longitudinal sectional view of a nozzle used for jetting hot air into the roast chamber.

FIG. 5 is a segmented top view on the top of the air distribution plate of the apparatus illustrating directions of air jets, positions of air outlet openings, and directions of movement of the coffee beans.

FIG. 6 is a fragmental vertical sectional view through the lower part of the roasting chamber.

### DETAILED DESCRIPTION OF THE INVENTION

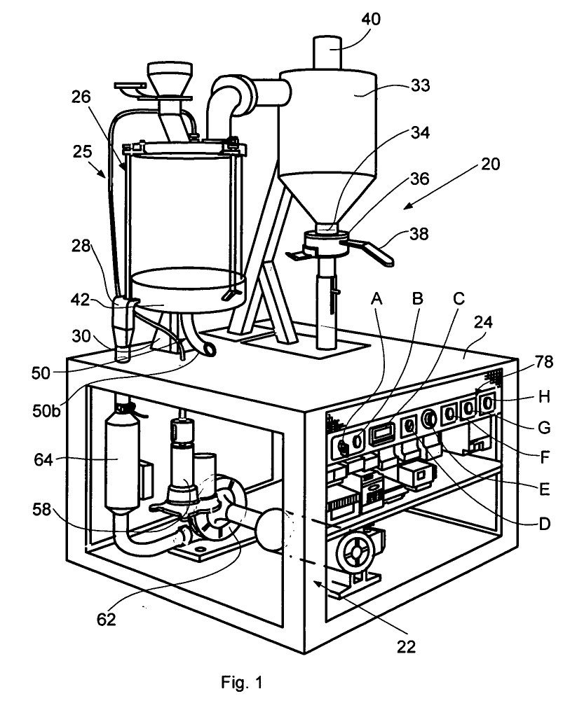

A general three-dimensional view of a coffee bean roasting apparatus 20 of the invention is shown in FIG. 1. It can be seen that the apparatus consists of a hollow rectangular base frame 22 that supports main functional units and devices on its top side 24 and retains all the drives and control devices inside.

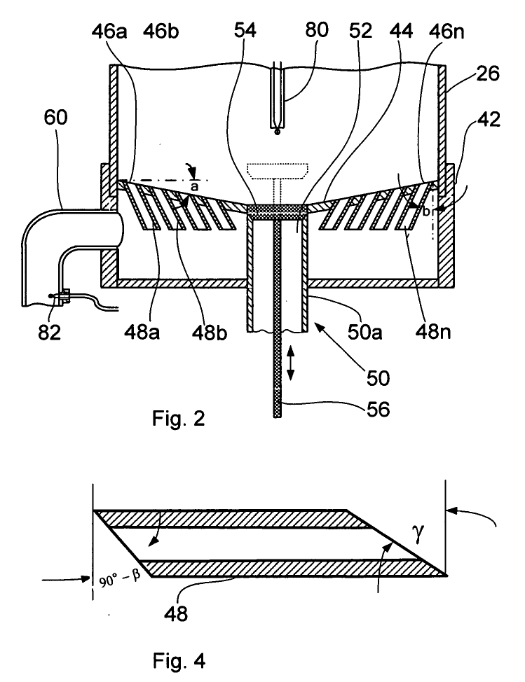

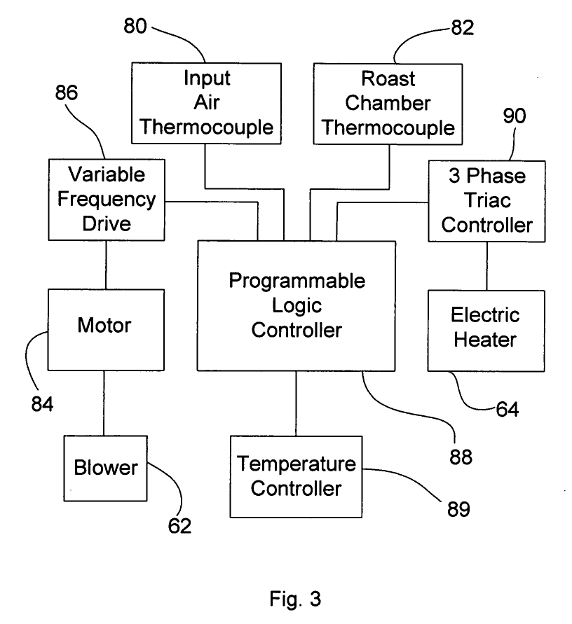

The main functional units and devices are comprised of a coffee bean treating unit 25 that consists of the following components: a cylindrical roast chamber 26 made from a transparent heat-resistant material such as a borosilicate glass, which is supported on the base-frame top 24 by a pair of stands 28 and 30; a roast chamber plenum 42 located in the lower part of the coffee bean treating unit 25, which is shown in more detail in FIG. 2; and a circular distribution plate 44 between the cylindrical roast chamber 26 and the roast chamber plenum 42. FIG. 2 is a sectional view through the roast chamber plenum 42 shown on a larger scale than FIG. 1. The control block diagram of the coffee roasting apparatus 20 (FIG. 1) is shown in FIG. 3.

A cyclone separator 33, which communicates with the cylindrical roast chamber 26, is intended for suction of the chaff under the effect of a pressure drop created by the cyclone separator 33 and for separation of coffee bean chaff from the hot air prior to exhaust thereof from the system. The cyclone separator is of a known design and operating principle. Briefly, it separates chaff from the flow of air coming from the roasting chamber 26. The lower end of the cyclone separator 33 forms a chaff collection cup 36 with a pull-down grip 38 for unloading the collected chaff. The chaff falls down into the chaff collection cup 36 by gravity through the tip of a cone and through a discharge tube 34. The air cleaned of chaff by centrifugal force exits at a top outlet 40.

It can be seen from FIG. 2 that the dispersion plate 44, which also constitutes a part of the coffee bean treating unit 25, has a shape tapered radially outward from the center of the plate. The dispersion plate 44 is made, e.g., from stainless steel, and has a plurality of outlet openings 46a, 46b, . . . 46n, which in fact constitute outlets of short inclined tubes 48a, 48b, . . . 48n or nozzles that protrude into the roast chamber plenum. The ends of the cylindrical nozzles 48a, 48b, . . . 48n on the distribution plate 44 are in flash with the surface of the distribution plate.

Taper angle “α” of the dispersion plate may vary in the range, e.g., of 10° to 20°, and angles “β” and γ” of inclination of the nozzles may vary, e.g., in the range of 15° to 80°. In fact, each nozzle is a short cylindrical tube 48 of the type shown in FIG. 4 with beveled end faces 48a and 48b on both sides of the tube 48.

Installed in the center of the roast chamber plenum 42 is an unloading channel in the form of a discharge tube 50 (FIG. 1) for unloading the roasted coffee beans from the cylindrical roast chamber 26 when the roasting operation is completed. The portion 50a of the discharge tube, which is located inside the roast chamber plenum 42, has a vertical orientation and its upper end terminates in the form of an inlet opening 52 in the center of the tapered dispersion plate 44, while the portion 50b (FIG. 1) of the discharge tube that extends from the bottom of the roast chamber plenum 42 is bent in the lateral direction and is used as an unloading spout for unloading the ready product to a receiving container (not shown). For this purpose, the outlet opening of the unloading spout is located on a certain height above the base frame top 24 in order to provide enough room for placing the receiving container.

The upper end of the discharge tube portion 50a serves as a seat for the head 54 of a plate-like valve that closes the inlet opening 52 of the discharge tube 50 during the roasting operation and which is raised above the dispersion plate into a position shown by broken lines (FIG. 2) high enough for unobstructed unloading of the roasted coffee beans from the cylindrical roast chamber 26 to the receiving container (not shown) through the discharge tube 50 when the roasting operation is over. Since the diameter of the inlet opening 52 is essentially smaller than the inner diameter of the cylindrical roast chamber 26 and since the beans are slightly mixed under the effect of the ejected air flows, the presence of a small imperforated area in the center of the distribution plate 44 formed by the valve head 54 will not affect uniformity of roasting.

The plate-like valve head 54 is moved in the vertical direction for opening or closing the inlet opening 52 (FIG. 2) of the discharge tube by a thin valve stem 56, which is vertically arranged in the center of the discharge tube portion 50a and is driven by a linear actuator 58 (FIG. 1) located inside the base frame 22. The diameter of the discharge tube 50 is large enough for unobstructed passage of the roasted beans.

The interior of the roast chamber plenum 42 communicates with a hot-gas entrance in the form of an inlet air duct 60, which is connected to a pressure blower 62 through a heater 64 (FIG. 1) intended for heating the pressurized air stream that enters the roast chamber plenum 42 and then is jetted through the aforementioned nozzles 48a, 48b, . . . 48n into the cylindrical roast chamber 26 in tangential directions to the mass of the coffee beans which should fill during roasting a certain volume in the lower part of the roast chamber with the unloading opening being closed by the valve as shown in FIG. 2 by solid lines.

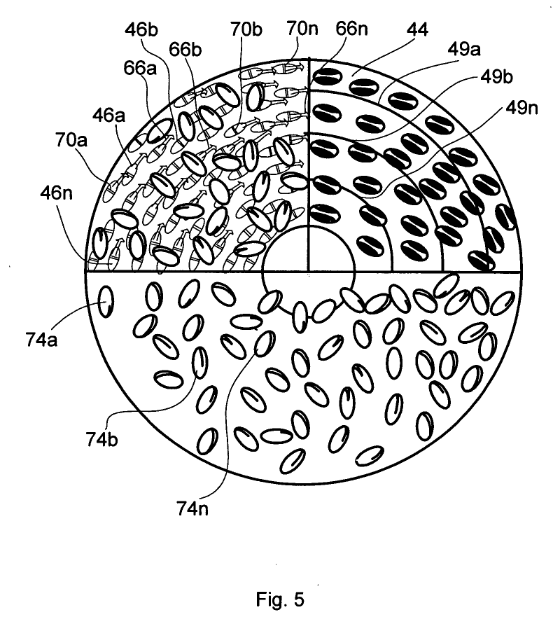

FIG. 5 is a top view on the distribution plate 44 in the cylindrical roast chamber 26. The lower section of the circular plate (i.e., the section from 3 o'clock to 9 o'clock of the clock face) shows the initial stage of roasting, when the coffee beans 74a, 74b, . . . 74n have just been loaded into the roast chamber 26 and have a chaotic orientation.

The upper left quadrant (from the 9 o'clock position to the 12 o'clock position of a clock face) shows the outlet openings 46a, 46b, . . . 46n of the distribution plate 44, which, in fact, constitute outlets of short inclined tubes 48a, 48b, . . . 48n or nozzles that protrude into the roast chamber plenum 42 (FIG. 2). Reference numerals 70a, 70b, . . . 70n designate separator wires arranged across the openings 46a, 46b, . . . 46n in order to protect the coffee beans from falling down into the roast chamber plenum 42 through the aforementioned openings. The arrows 66a, 66b, . . . 66n show direction of hot air jets emitted from the nozzles 48a, 48b, . . . 48n into the cylindrical roast chamber 26. It can also be seen from FIG. 5 that the outlet openings 46a, 46b, . . . 46n are oriented in tangential directions to concentric circles 49a, 49b, . . . 49n within a contour of the circular distribution plate.

The upper right quadrant (from 12 o'clock to 3 o'clock of the clock face) is a top view of the coffee beans 74a, 74b, . . . 74n fluidized and oriented under the effect of the tangential jets of hot air in the direction of the aforementioned concentric circles. The outlet openings are not shown in this section of the drawing.

The drive, control mechanisms and devices of the coffee roasting apparatus 20 of the invention are kept inside the base frame 22 (FIG. 1) while the control panel 78 of the apparatus 20 with various control buttons, switches, indicators, and displays (or LCD operator interface) is located on the front side of the base frame 22.

Important components of the control system are two temperature measurement devices, i.e., a first temperature measurement device in the form of an input airflow thermocouple 80 installed in the inlet air duct 60 for measuring temperature of the inlet airflow and a second temperature measurement device in the form of a roast chamber thermocouple 82 for measuring temperature of beans in the cylindrical roast chamber 26 (FIG. 2).

Pressurized flow of air is created by the air blower 62 that is driven by an electric motor 84 controlled by a variable frequency drive 86 (FIG. 3). On its way to the roast chamber plenum through the inlet air duct 60 (FIG. 2), the air flow passes through the heater 64 which may be an electric or gaseous air heater (FIGS. 1 and 3). The latter is connected to a programmable logic controller 88 (hereinafter referred to as PLC), which is connected to a temperature controller 89, the aforementioned input airflow thermocouple 80 and the roast chamber plenum thermocouple 82 (FIG. 3). The function of the PLC 88 is to maintain a predetermined temperature differential between the temperature of the inlet air flow and the temperature of the beans in the roast chamber 26. The programmable controller 88, in turn, is connected through a three-phase triac controller 90 to the aforementioned heater 64 for adjusting heating temperature in response to the output data of the aforementioned thermocouples 80 and 82.

The control buttons, switches, displays, and indicators on the control panel 78 include the following: a key switch A that, when switched, activates the PLC 88; a bean-size selector switch B, which is needed since the size, grade, and other conditions of the coffee beans affect the roasting regime; a temperature indicator and setpoint controller C; a profile selector switch D; an emergency heat-off switch E; a start switch F activation of which automatically energizes the blower and the heater; a bean unload switch G that energizes the valve-lift actuator 58 (FIG. 1); and a stop switch. (The abovementioned controls can be consolidated in an LCD operator interface as well).

The apparatus 20 operates as follows.

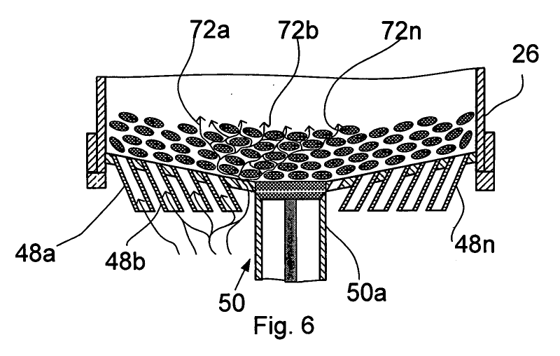

A measured amount of beans is introduced into the borosilicate cylinder roast chamber 26. The system is energized with the key switch A (FIG. 1), which enables the PLC controller 88. Pushing the start switch F simultaneously activates the pressure blower 62 and the heater 64. The resultant heated airstreams passes in the form of multiple tangential jets 76a, 76b, . . . 76n through the numerous tangential nozzles 48a, 48b, . . . 48n of the dispersion plate 44. As shown in FIG. 6, which is a fragmental vertical sectional view through the lower part of the roasting chamber 26, the jets 72a, 72b, . . . 72n (FIGS. 5 and 6) create a floating bed for the beans which keep the beans 72a, 72b, . . . 72n in a rotating and floating state in the form of laminated layers 72a1, 72b1 . . . 72n1 of discrete bodies of the beans, wherein the beans of each layer essentially do not collide with the beans of the neighboring layers but rather rotate under the effect of the tangential jets 72a, 72b, . . . 72n as a unity and without relative movements with respect to each other. Such a condition protects the beans 72a, 72b, . . . 72n from deterioration that normally occurs when the beans collide with each other. At the same time, the individual beans 72a, 72b, . . . 72n are located in close heat-transfer proximity to each other so that the entire bean load moves as a homogenous virtual solid mass having a uniform temperature through all the layers. Under such conditions the temperature of the beans 72a, 72b, . . . 72n determined by the in the roast chamber thermocouple 82 in the bean mass will be substantially the same as in the layers close to the dispersion plate 44 (FIGS. 2 and 6).

The PLC 88 monitors and controls the bean load in the roast chamber 26 with resolution of 0.01 seconds. With the roast chamber thermocouple 82 sampling the temperature of the beans and the inlet air thermocouple 80 sampling the inlet air temperature, the PLC 88 continuously changes temperature of the bean load with 1° C. of increase (or decrease) maintaining the predetermined temperature differential, e.g., 30° C. differential, between the two points of measurement. When the temperature reaches the predetermined setpoint, the heater turns off and the cooling process begins.

The PLC 88 determines how to maintain the proper temperature of the heated airstreams and regulates it utilizing a three-phase proportional triac controller 90, which, in turn, controls the heater 64 (which in this case is an electric heater).

The PLC 88 determines how to maintain the proper airstreams pressure and volume and regulates the pressure blower 62 utilizing a variable frequency drive 86 determined by existing measured temperatures.

As the coffee beans cook, the resultant effluent flow is directed through the cyclone separator 33, which through its cyclonic action and predetermined pressure drop collects any solids (e.g., chaff), to be removed though the top outlet 40 after the end of the roast cycle.

A temperature controller 89 displays the process temperature and allows the user to select the temperature setpoint at which he/she wants the roast process to end. Depending on which profile and what setpoint temperature is selected, the roasting process takes between 4 and 13 minutes. These profiles are switch-selectable on the front panel.

Normally the bean cooking temperature will be determined by the preset temperature differential and should not exceed 240° C. If the temperature exceeds the recommended upper limit, the PLC will automatically adjust said temperature to remain at or below the upper limit.

Once setpoint has been achieved, the heating unit 64 is turned off and the cooling cycle begins.

The PLC 88 determines how to maintain the proper airstreams pressure and volume based on the cooling temperature and directs the variable frequency drive 86 to alter the speed of the pressure blower 62. Cooling takes approximately 2 minutes.

When the cooked beans have cooled to a required temperature, e.g., 82° C., the PLC 88 allows the operator to select the unload switch (not shown) enabling the linear actuator 58 to raise the valve head 54, and the beans are displaced into the receiving container (not shown) through the discharge tube 50. Two additional pulses of air make sure no beans remain in the roast chamber 26.

Closing the outlet valve completes the process and resets the PLC data registers to allow for the next roast process.

The method of the invention consists of providing a coffee roasting apparatus having a cylindrical coffee bean roast chamber, a roast chamber plenum having a hot-gas entrance and located underneath the coffee bean roast chamber, and a circular distribution plate between the coffee bean roast chamber and the roast chamber plenum, a first temperature measurement device for measuring temperature of the coffee beans in the cylindrical coffee bean roast chamber, a second temperature measurement device for measuring temperature at the hot-gas entrance, and a source of pressurized hot gas; loading a mass of coffee beans into the cylindrical coffee bean roast chamber; generating a pressurized flow of hot gas and directing this flow onto the mass of the beans through the distribution plate in the form of a plurality of hot gas jets directed tangentially to a plurality of concentric circles formed inside the contours of the cylindrical coffee bean roast chamber thus fluidizing the coffee beans and causing the mass of coffee beans to rotate in the direction of the aforementioned jets.

According the method of the invention, a constant temperature difference is maintained between the temperature of the mass of coffee beans and the temperature at the aforementioned hot-gas entrance.

Another aspect of the method consists of rotating the aforementioned mass of coffee beans substantially as an integral mass without relative movement of the beans with respect to each other.

According to the method, operation of the apparatus is controlled by a programmable logic controller that is connected to the first temperature measurement device, the second temperature measurement device, and the source of pressurized hot gas for maintaining movement of the aforementioned mass of coffee beans substantially as an integral mass without relative movement of the beans with respect to each other.

Thus, it has been shown that the present invention provides an apparatus and method for fluidized-bed coffee bean roasting that ensures complete fluidization of the beans during treatment, movement of the beans as a unity of discrete solids which do not have movement relative to each other, stable roasting temperature, uniform heating of the bean mass needed for uniform pyrolysis, and controlled circulation of the beans in horizontal planes under conditions of real fluidization at which the beans circulate as laminated flows with efficient and uniform transfer of heat between the layers.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the apparatus and method of the invention are applicable not only for coffee beans but for treating any other products such as coca beans, grains, nuts, etc., that may require treatment with uniform temperature and other controlled conditions. The heater may be electrical or gaseous. The hot air may circulate with return back to the system from the output of the cyclone separator. Different temperature control methods and devices can be used. For example temperature in the roast chamber and in the inlet pipe can be measured by semiconductor thermometers. An air compressor can be used instead of an air blower, and gas other than air can be used for heating the beans.

What I claim is:

1. A coffee bean roasting apparatus comprising:
a coffee bean treating unit consisting of a cylindrical coffee bean roast chamber, a roast chamber plenum having a hot-gas entrance and located underneath the coffee bean roast chamber, and a circular distribution plate between the coffee bean roast chamber and the roast chamber plenum, the distribution plate having a taper angle and tapering radially outward from the center of the distribution plate and having a plurality of outlet openings oriented in tangential directions to concentric circles within a contour of the circular distribution plate;
a source of hot pressurized gas comprising a source of pressurized gas and a heater for heating the pressurized gas and for directing the hot pressurized gas onto a mass of coffee beans that fills the coffee bean roast chamber through the roast chamber plenum and the aforementioned outlet openings in the aforementioned tangential direction for rotation of the mass of coffee beans in a fluidized state as an integral unit without relative movement between the beans;
a roasted bean unloading device comprising an unloading channel in the center of the distribution plate and a mechanism for closing and opening the aforementioned unloading channel; and
a control system for maintaining the pressure and temperature of pressurized gas under conditions that provide aforementioned rotation of the mass of beans in a fluidized state essentially as an integral unit practically without relative movement between the beans and with uniform heat transfer between the beans.

2. The apparatus of claim 1, wherein the outlet openings oriented in tangential directions to concentric circles are outlet openings of cylindrical nozzles attached to the distribution plate from the side of the roast chamber plenum, the cylindrical nozzles comprising cylindrical tubes with end faces beveled at a bevel angle, the ends of the cylindrical nozzles on the distribution plate being in flash with the surface of the distribution plate.

3. The apparatus of claim 2, wherein the ends of the cylindrical nozzles on the distribution plate have separator wires arranged across the aforementioned outlet opening for preventing drop of the coffee beans into the roast chamber plenum through the aforementioned nozzles.

4. The apparatus of claim 1, wherein the aforementioned control system comprises: a first temperature measurement device located in the cylindrical coffee bean roast chamber in a position that provides measurement of the bean temperature, a second temperature measurement device located at the aforementioned hot has entrance; a drive device of the aforementioned source of pressurized gas; and a programmable logic controller connected to the first temperature measurement device, the second temperature measurement device, the drive device of the source of pressurized gas, and the heater.

5. The apparatus of claim 4, wherein the aforementioned programmable logic controller has means for maintaining a constant temperature difference between temperature measured by the first temperature measurement device and temperature measured by the second temperature measurement device during operation of the apparatus.

6. The apparatus of claim 5, wherein the drive device of the source of pressurized gas is a variable frequency drive controlled electric motor, the heater is an electric heater, and wherein aforementioned control system is further provided with a three-phase triac controller through which the programmable logic controller controls operation of the electric heater.

7. The apparatus of claim 1, wherein the mechanism for closing and opening the aforementioned unloading channel comprises a plate-like valve with a valve head that closes and opens the aforementioned unloading channel, a valve stem connected to the valve head, and an actuator connected to the valve stem for moving the valve stem between opening and closing positions of the unloading channel.

8. The apparatus of claim 7 wherein the aforementioned control system comprises: a first temperature measurement device located in the cylindrical coffee bean roast chamber in a position that provides measurement of the bean temperature, a second temperature measurement device located at the aforementioned hot-gas entrance; a drive device of the aforementioned source of pressurized gas; and a programmable logic controller connected to the first temperature measurement device, the second temperature measurement device, and the drive device of the source of pressurized gas.

9. The apparatus of claim 8, wherein the programmable logic controller is connected to the aforementioned heater for discontinuing heating of coffee beans when the temperature of the beans reaches a predetermined value.

10. The apparatus of claim 2, wherein the taper angle ranges from 10 to 20°, and the bevel angle ranges from 15 to 80°.

11. The apparatus of claim 4, wherein the pressurized gas is pressurized air, the first temperature measurement device is a first thermocouple, and the second temperature measurement device is a second thermocouple.

12. The apparatus of claim 5, wherein during operation of the apparatus the aforementioned programmable logic controller maintains a constant temperature difference between temperature measured by the first temperature measurement device and temperature measured by the second temperature measurement device.

13. The apparatus of claim 12, wherein the drive device of the source of pressurized gas is a variable frequency drive controlled electric motor, the heater is an electric heater, and wherein aforementioned control system is further provided with a three-phase triac controller through which the programmable logic controller controls operation of the electric heater.

13. The apparatus of claim 1, further comprising a cyclone separator connected to the cylindrical coffee bean roast chamber for receiving hot air from the cylindrical coffee bean roast chamber, for separation of coffee bean chaff from the hot air, and for discharge of the hot air from the cyclone separator after separation of chaff.

14. The apparatus of claim 13, wherein the aforementioned control system comprises: a first temperature measurement device located in the cylindrical coffee bean roast chamber in a position that provides measurement of the bean temperature, a second temperature measurement device located at the aforementioned hot has entrance; a drive device of the aforementioned source of pressurized gas; and a programmable logic controller connected to the first temperature measurement device, the second temperature measurement device, the drive device of the source of pressurized gas, and the heater.

15. The apparatus of claim 14, wherein during operation of the apparatus the aforementioned programmable logic controller maintains a constant temperature difference between temperature measured by the first temperature measurement device and temperature measured by the second temperature measurement device.

16. A method of roasting coffee beans comprising the steps of:
providing a coffee roasting apparatus having a cylindrical coffee bean roast chamber, a roast chamber plenum having a hot-gas entrance and located underneath the coffee bean roast chamber, and a circular distribution plate between the coffee bean roast chamber and the roast chamber plenum, a first temperature measurement device for measuring temperature of the coffee beans in the cylindrical coffee bean roast chamber, a second temperature measurement device for measuring temperature at the hot-gas entrance, and a source of pressurized hot gas;
loading a mass of coffee beans into the cylindrical coffee bean roast chamber; and
generating a pressurized flow of hot gas and directing this flow onto the mass of the beans through the distribution plate in the form of a plurality of hot gas jets directed tangentially to a plurality of concentric circles formed inside the contours of the cylindrical coffee bean roast chamber thus fluidizing the coffee beans and causing the mass of coffee beans to rotate in the direction of the aforementioned jets.

17. The method of claim 16, further comprising the step of maintaining a constant temperature difference between the temperature of the mass of coffee beans and the temperature at the aforementioned hot-gas entrance.

18. The method of claim 17, further providing the step of rotating the aforementioned mass of coffee beans substantially as an integral mass without relative movement of the beans with respect to each other.

19. The method of claim 16, further comprising the step of controlling operation of the apparatus by means of a programmable logic controller that is connected to the first temperature measurement device, the second temperature measurement device, and the source of pressurized hot gas for maintaining movement of the aforementioned mass of coffee beans substantially as an integral mass without relative movement of the beans with respect to each other.

20. The method of claim 17, further comprising the step of controlling operation of the apparatus by means of a programmable logic controller that is connected to the first temperature measurement device, the second temperature measurement device, and the source of pressurized hot gas for maintaining movement of the aforementioned mass of coffee beans substantially as an integral mass without relative movement of the beans with respect to each other.
